(19) United States
(12) Patent Application Publication
(10) Pub. No.: US 2017/0230495 A1
(43) Pub. Date: Aug. 10, 2017

(54) ULTRA QUICK MESSAGING & CONNECTED PHONEBOOKS DEVICE

(71) Applicant: Vishal GUPTA, Delhi (IN)

(72) Inventor: Vishal GUPTA, Delhi (IN)

(21) Appl. No.: 15/501,826

(22) PCT Filed: Aug. 8, 2015
(86) PCT No.: PCT/IN2015/050085

§ 371 Date: Feb. 6, 2017

Related U.S. Application Data
(60) Provisional application No. 62/035,029, filed on Aug. 8, 2014.

(51) Int. Cl. H04M 1/725; H04M 1/2745; H04W 4/20

(52) U.S. Cl. CPC H04M 1/72547; H04W 4/20; H04M 1/274558; H04M 1/274583; H04M 2203/4509

(57) ABSTRACT

The present invention relates to system (100) and method for providing ultra-quick audio/video messaging phonebook and delivery. The system (100) includes an application server communicating with one or more communication devices (D1, D2), each device having an application installed therein. The application configures a device to display all contacts including registered and unregistered contacts available in memory (401) of the device. When a user selects and holds a contact, application initiates a short duration audio/video message recording for the selected contact (403) and detects whether the selected contact is a registered or an unregistered contact number of the application (4040). If the selected contact is recognized as a registered contact, the application automatically transmits the recorded message to the selected contact via the application server upon release of hold to contact (406). If selected contact is recognized as an unregistered contact, the application automatically transmits a message along with a unique web link to provide direct web access to the recorded audio/video message to the selected contact/recipient.

### FIELD OF THE INVENTION

The present invention relates to an automatic audio/video message delivery in the field of telecommunication. More particularly, relates to a system and method for providing ultra-convenient time saving audio/video recorded message delivery on remote devices.

### BACKGROUND OF THE INVENTION

Now days several messaging application and platform are available for providing voice messaging functionality. What's app which is one of these, has a great messaging system including a method to send audio/voice messages in a chat room. Apart from messaging platforms there are some audio/voice activated answering machines being sold from some time. The audio/voice command has now become very much common for controlling the operation of device. The audio/voice command controlled devices are now day's speaker independent. Phones usually carry software like SIRI or DRAGON to listen voice instruction and execute the operations on device.

In such above devices a new technology has been introduced, known as Always-on MotionQ technology, which is a low power always on audio processing chip for mobile phones having a dedication core on processor or a separate chip for continuous listening of audio commands.

However, currently available audio/video messaging systems do not provide a smart quick audio/video messaging functionality which enhances the system efficiency and user experience by providing flexible and quick time saving audio/video message delivery as well as answering options in a single platform.

Therefore there is a need for a method or system which eliminates problems associated with currently available audio/video messaging platforms and provides a unified ultra-quick audio/video messaging delivery system.

### SUMMARY OF THE INVENTION

An object of the present invention is to provide a method for automatically delivering at least one of a audio and video message comprising providing a phonebook directory application, comprising one or more registered and unregistered contacts in a contact list at least one of a first and second communication devices, prioritizing the one or more registered and unregistered contacts in the contact list of the phone book directory application, cueing to initiate recording of a message to at least one of the registered and unregistered contact of the contact list on the first communication device, by selecting and holding at least one of the registered and unregistered contact of the contact list, processing the recorded message comprising one of a transmitting the recorded message to the selected registered contact associated with the second communication device upon release of the selected registered contact at the first communication device and transmitting the recorded message to the selected unregistered contact associated with the second communication device upon release of the selected unregistered contact at the first communication device having the recorded message comprises a unique web link to a phonebook directory web portal providing direct access to message and receiving a notification of the transmitted message on being played.

An object of the present invention is to provide a method of automatically delivering at least one of a audio and video message comprising receiving a recorded message from a first communication device at a second communication device, detecting status of the second communication device on receiving the recorded message, switching on one or more transducers configured to receive a user input without physically touching the second communication device and automatically playing the received recorded message based on the detected status and the user input.

An object of the present invention is to provide a method for prioritization of the one or more registered and unregistered contacts in the phonebook directory application further comprising the steps of displaying the one or more registered and unregistered contacts of the contact list of the phonebook directory application, wherein the one or more registered and unregistered contacts comprises one or more field sections, receiving an alphanumeric characters entry in the phonebook directory application, initiating searching in the one or more fields of the one or more contacts, sorting the contacts based on matches beginning with the search string and then later containing the search string, further sorting the contacts based on the matched fields having higher importance within the contacts having same sort order, further sorting contacts based on usage within the contacts having same order and presenting the sorted contacts in the phonebook directory application.

An another more object of the present invention is to provide a contact prioritization mechanism, wherein the prioritization of at least one of contact in the phonebook directory application further comprising the steps of displaying the one or more contacts of the phonebook directory, wherein the contact comprises one or more field sections, receiving an alphanumeric characters entry, initiating searching in the one or more field sections of the contact from beginning, for each of the alphanumeric character entry, and presenting the contacts associated with the one or more field sections, having all of the alphanumeric character entries from the beginning of the field section.

An another more object of the present invention is to provide portable communication device that can send a message to a user within a single click and also receive a reply from the recipient without needing to touch his mobile phone.

An another more object of the present invention is to provide portable communication device that is optimized to save time of the user by pre-emptively updating the phone contact book with availability information of other users to save time.

### BRIEF DESCRIPTION OF THE DRAWINGS

Other objects, features, and advantages of the invention will be apparent from the following description when read with reference to the accompanying drawings. In the drawings, wherein like reference numerals denote corresponding parts throughout the several views:

FIG. 1 shows a simplified block diagram of a system (100) architecture in accordance with an embodiment of the present invention.

FIG. 2 and FIG. 3 shows a diagram depicting of operation of the audio/video message delivery as web quick audio/video recording (Qviki) to a user of communication device according to an embodiment of present invention.

FIG. 4 shows a diagram depicting a flow chart illustrating phonebook directory operation for registered and unregistered contacts according to an embodiment of present invention.

FIG. 5 shows a diagram depicting a flow chart illustrating phonebook directory operation according to an embodiment of present invention.

FIG. 6 and FIG. 7 shows a diagram depicting phonebook directory application request flow processing between server and communication devices in online mode according to an embodiment of present invention.

### DETAILED DESCRIPTION OF THE PREFERRED EMBODIMENTS

Throughout the following discussion, numerous references will be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, DSP, x86, ARM, ColdFire, GPU, multi-core processors, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, a circuit-switched network, the Internet, LAN, WAN, VPN, or other type of network.

The terms “configured to” and “programmed to” in the context of a processor refer to being programmed by a set of software instructions to perform a function or set of functions.

One should appreciate that the disclosed contacts directory discovery system provides numerous advantageous technical effects. For example, the contacts directory discovery system of some embodiments enables up-to-date contact information by methodically allowing the persons to update and edit contacts and contact information in shared directories.

The following discussion provides many example embodiments. Although each embodiment represents a single combination of components, this disclosure contemplates combinations of the disclosed components. Thus, for example, if one embodiment comprises components A, B, and C, and a second embodiment comprises components B and D, then the other remaining combinations of A, B, C, or D are included in this disclosure, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, numerical parameters expressing quantities are used. It is to be understood that such numerical parameters may not be exact, and are instead to be understood as being modified in some instances by the term “about.” Accordingly, in some embodiments, a numerical parameter is an approximation that can vary depending upon the desired properties sought to be obtained by a particular embodiment.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, ranges set forth herein should be interpreted as being inclusive of their endpoints and open-ended ranges should be interpreted to include only commercially practical values. The recitation of ranges of values herein is merely intended to serve as a shorthand method of referring individually to each separate value falling within the range. Unless otherwise indicated herein, each individual value within a range is incorporated into the specification as if it were individually recited herein. Similarly, all lists of values should be considered as inclusive of intermediate values unless the context indicates the contrary.

Methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the described concepts and does not pose a limitation on the scope of the disclosure. No language in the specification should be construed as indicating any non-claimed essential component.

Groupings of alternative elements or embodiments of the inventive subject matter disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

This disclosure allow for construction or configuration of a computing system or device to operate on vast quantities of digital data, beyond the capabilities of a human. The computing system or device is able to manage the digital data in a manner that could provide utility to a user of the computing system or device that the user would lack without such a tool.

The present invention will now be described in detail with reference to the accompanying drawings.

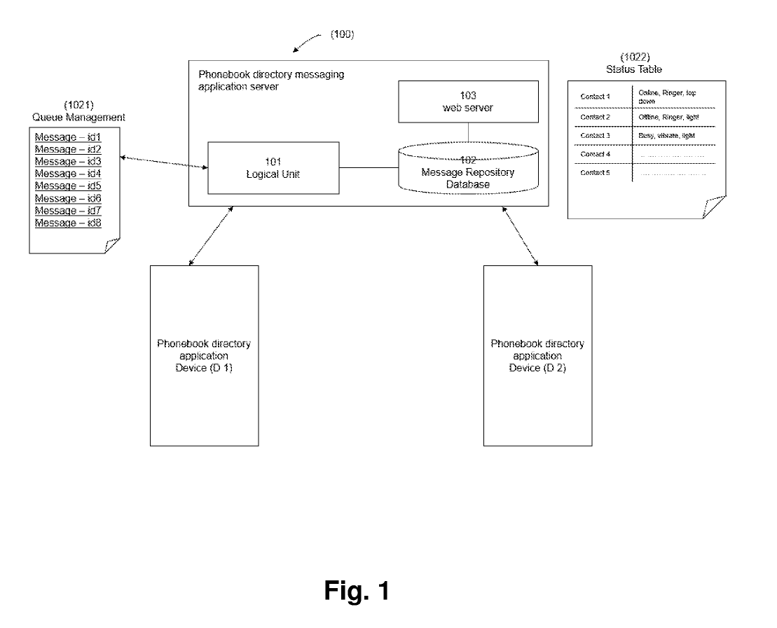

FIG. 1 shows a simplified block diagram of the system (100) architecture in accordance with an embodiment of the present invention. The system includes phonebook directory messaging application platform (100) and communication device (D1, D2), phonebook directory application installed therein. The system (100) includes a logical unit (101), web server (103) and message repository database. The logical unit (101) is the brain of the system to perform all function from taking request to play audio/video call message on recipient devices. The logical unit (101) coupled to a message repository database (102) storing various information including audio/video messages, device status information received form devices D1, D2, user profile details etc. The database (102) is also coupled to webserver providing web access to audio/video message received via message containing web address. The logical unit (101) communicates with devices D1 and D2. It also channelize device D2 status information to user of devices D1 and vice versa. The phonebook directory application on device D1 and D2 utilizes this status information for the prioritization of contact with the user defined instructions. The database (102) maintains a table containing contact device identifier and associated device status information in a predefined tabular format (1022), the device status information includes information received from device operating system about operational states (busy, engaged, online etc) and information (top down or up, holding etc) received from device sensors. The operating system monitors operation states details and sensory information on real-time basis and transmits to the logical unit (301). The logical unit (101) collects and stores this information in a pre-defined format into database (102). The operation states of communication device is determined by device operating system (OS), the state information includes busy, available, engaged, conversing, listening, out-of-range, and not logged on. Further, typically devices D1, D2 includes one more sensors for detecting and controlling various function of device, including gyroscope sensor, light sensor, proximity sensor and gravity sensors, the present invention is not limited to above sensors only, it can be any sensor that can be used for detecting device states.

The device D1 user selects and holds contact at D1 display, for initiating audio/video recording, and upon release of the contact on device D1 a request is generated and received at logical unit (101) at central server platform (100). The contact can be contact information such as name of recipient and number. The logical unit (101) checks present status of recipient's device D2 in status table (1022). If device is available for and any other predefined instruction is not given by the recipient, audio/video message is delivered to the D2 and an audio or visual alert is generated via output transducers such as speaker, vibrator or, display light in response to receiving, Further, if recipient seems busy, engaged, conversing, listening, out-of-range, and not logged on or any another instruction is defined by the recipient for respective senders, message is delayed delivered to the recipient. For example during message delivery to recipient device D2, if D2 is detected as busy from table (3032), and user device detected as top down position by light sensors, audio/video message is delivered to recipient, and an audio (small beep) alert will be given to the recipient. Similarly, in an another scenario if device is detected as top up position in above scenario an audible as well as light alert will be given to the recipient. Further, if recipient device is detected as conversing or engaged, recipient gets a vibration and light alert on receiving of audio/video message instead of audio or visual only.

The logical unit (101) also does queue management of audio/video recorded message to a recipient. If one or more message for a recipient device is received simultaneously, each message is lined up into a queue. A queue management table (1021) is shown. In another embodiment of present invention the queue management can be done either at server or devices, thus audio/video recorded message is queued either on the server or the device till the recipient device becomes available for automatic play. For example the audio/video recorded message is queued if the user is on call or the device is on silent mode. It will be played automatically as soon as the device is available or the ringer is activated.

In an another embodiment of present invention, if recipient has some predefined instruction set for this sender such as a higher priority, the audio/video message from this sender will be auto played on device D2 without even alerting to recipient and the rest messages are queued for time being. The other benefit is the user saves time by not having to wait for voicemail or call ringing. The user may leave a detailed message without having to type and disturb or wait for the receiver to pick a call.

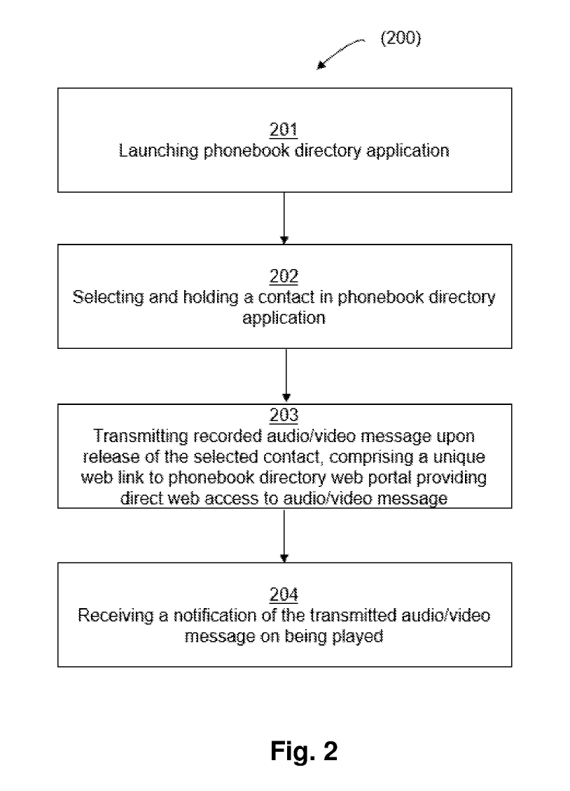

FIG. 2 shows a diagram depicting an operation of the audio/video message delivery as web quick audio/video recording (Qviki) to a user of communication device according to first embodiment of present invention. According to the first embodiment of the present invention, a user communication device comprises a phonebook directory application of the present invention installed therein. Once the installed application is launched (at step 201) in a communication device, all available contacts are retrieved from the local memory and displayed over the screen. These contacts may include valid (online), non-users of phonebook directory application and offline contacts. When device user (at step 202) selects and holds a contact appeared on the screen, a cue generates for indicating audio/video message recording in phonebook directory application. The application invokes an audio/video recording operation via microphone/camera of device for a short duration at the background of the application, and upon release of the selected contact (at step 203), automatically sends recorded audio/video message to the selected contact associated with recipient user communication device. The transmitted message at step (203) is an audio/video message containing a unique web address to access the audio/video message on recipient device web browser. The web address provided in the message is specific to the selected contact only and a valid recipient device can only access the audio/video message on web portal in device web browser. When user clicks on the web address, it is redirected to the audio/video messaging web portal server (103) for listening/viewing audio/video message. In response to click on above step (203) a notification as an acknowledgement is transmitted back to the audio/video message sender device.

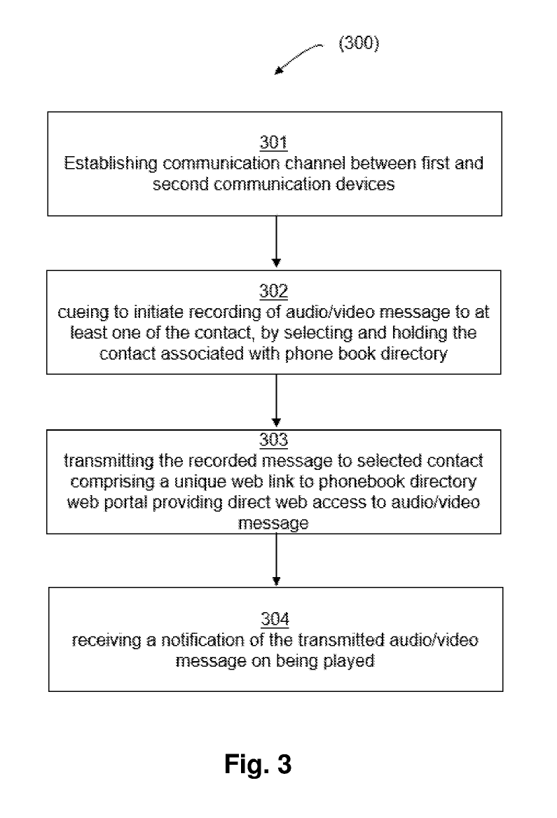

FIG. 3 shows a diagram depicting phonebook directory application request processing between communication devices according to the second embodiment of the present invention. The phonebook directory application installed on the first user communication device initially establishes a communication (at step 301) with one or more second communication devices via phonebook directory application server. The establishment of communication channel between first and second communication devices provide both application users their contacts status information. The status information gives device users real-time status details about the recipients device such as busy, online/available, engaged, conversing, listening, out-of-range, and offline/not logged on. Once the channel between the first communication device and second communication device is established, a device user may select and initiate a search request for sorting available contacts. When an user select and hold appropriate contact (at step 302), for message transfer, it cues an indication for recording audio/video message, and start recording until user holds selection for a small duration. The message during recording is stored locally in local cache memory of first communication device and upon release of hold of selected contact, the recorded audio/video message data is automatically sent (at step 303) to second communication device of associated contact. The transmitted audio/video message can be in the form of audio/video mail or SMS containing web address of the audio/video messaging portal. The recipient at second communication device may play message directly from the device or by clicking on the web address provided in the SMS. Once a user plays or clicks on the web-address, an acknowledgement notification is reverted back (at step 304) to the sender communication device. The notification may be in the form of an audible or visual alert to the sender. The user's clicks on web address redirects him towards a unique URL specific to the contact on a web portal which allows him to listen/view to audio/video message. The web portal provides secure and private access to audio/video message specific to valid recipient.

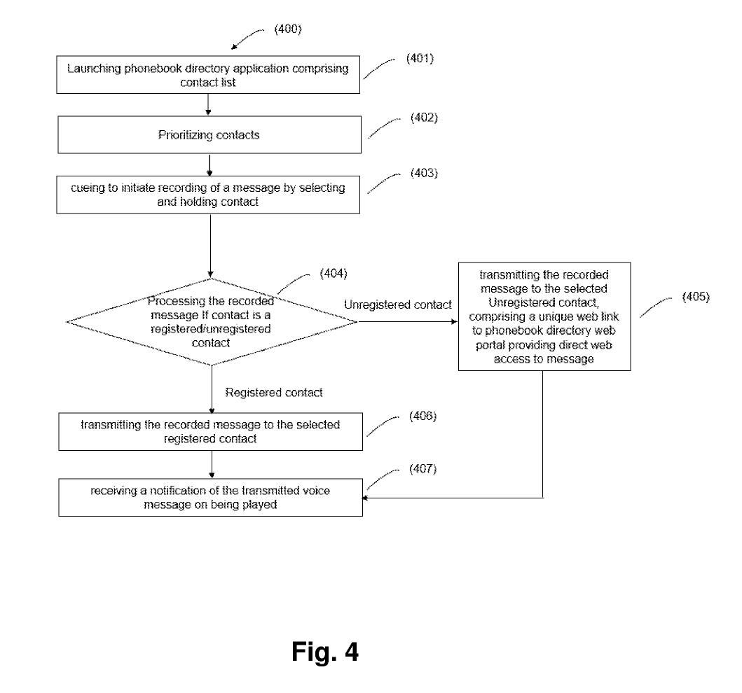

FIG. 4 shows a diagram depicting a flow chart illustrating method of audio/video message delivery for registered and unregistered contacts according to the third embodiment of present invention. According to this embodiment a phonebook directory application comprises a contact list of registered and unregistered contact numbers. A first and second communication device comprises the phonebook directory application installed therein. Once the installed application is launched (at step 401) all registered and unregistered contact retrieved form the local memory of the device. The registered contacts are valid users and unregistered contacts non-users of phonebook directory application stored in device memory. At step (402) contacts are prioritized based on the user input information. At step (403) first device user selects and holds a contact to initiate recording of audio/video message to selected contact, during this stage device application detects whether the contact is a registered contact or unregistered contact of the phonebook directory application. The detected registered and unregistered information at step (404) is used for processing the recorded audio/video message delivery based on the type of contact. If detected contact recognized as registered contact, upon release of hold of contact on phonebook display, recording stops and recorded audio/video message is automatically sent to registered contact number (at step 406) associated with a second communication device. If detected contact recognize as non-registered contact or unregistered contact, upon release of hold of contact, recording stops and a message comprising a unique web link to phonebook directory web portal providing direct web access to recorded audio/video message is transmitted (at step 405) to unregistered contact number. A notification of the transmitted message on being played by registered or unregistered contact user, is reverted back (at step 407) to the user of first communication device. According to an embodiment of the present invention the notification can be an audio or visual alert to the user of first device. The transmitted message to unregistered user can be a short message service (SMS), email containing web link to access recorded message.

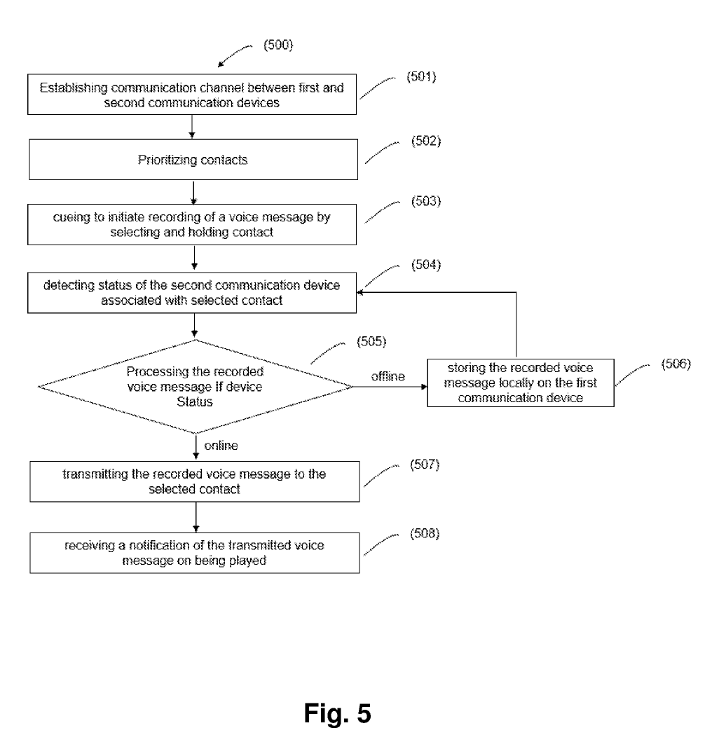

FIG. 5 shows a diagram depicting a flow chart illustrating method of audio/video message delivery according to an embodiment of present invention. At step (501) first communication device establishes communication channel with the one or more second communication devices via phonebook application server. The application server provides status information to the user of first and second devices about available contacts including operation state information of connected communication devices. Based on status information and user predefined input information, contacts are prioritized at step (502), in first and second communication devices. At step (503) first device user selects and holds a contact to initiate recording of audio/video message to selected contact, during this stage device application may detect status of the second communication device associated with the selected contact. The detected device status information includes such as device is in online mode or offline mode during the communication. The detected status information at step (505) is used for processing the recorded audio/video message based on the status of selected contact. If detected second device associated with the selected contact is recognized as offline, upon release of hold of contact on phonebook display, recording stops and recorded audio/video message is stored locally on the first communication device (at step 506). If detected second device status associated with the selected contact is recognized as online, upon release of the hold of selected contact on phonebook display, recording stops and recorded audio/video message is automatically sent to selected contact on second communication device (at step 507). A notification of the transmitted message on being played, is reverted back (at step 508) to the user of first communication device. According to an embodiment of the present invention the notification can be an audio or visual alert to the user of first device. Further, if after sometime or during later stages when device comes online, the locally stored audio/video recorded message is sent to second communication device.

According to an embodiment of present invention a user predefined input information comprises a user entry for sorting a contact. The present invention provides an efficient searching mechanism for prioritization of a contact. In present invention sectional searching mechanism is provided for the contact prioritization. In which for a subsequent alphanumeric character entry phonebook directory is checked for “First Name” section up to certain length from the beginning of “First Name”. For second subsequent alphanumeric character entry “Last Name” section of phonebook directory is also searched from the beginning of “Last Name” together with first entry. Further for other more entries “Phone number” section “Organization” section, “Email” section, “Group” section, are searched in parallel from the beginning up to certain length with the previous entries. On the basis for searched relevant results contacts are prioritized and comes up in the phonebook directory.

According to an another embodiment of the present invention provides an efficient searching mechanism for prioritization of a contact comprising sectional searching mechanism including prioritization of sorted contact based on classification and usage history of contact. In which for a subsequent alphanumeric character entry phonebook directory is first checked for contacts field from the beginning of field for matched entries as first step and then the contact fields containing alphanumeric character entry as second step for sorting the contact. The contact start with alphanumeric character entries and contains alphanumeric character entries are sorted in above steps. The contacts as sorted in above steps are further sorted based on the classification of contacts such as higher importance and then further sorted based on the utilization history of contact data. On the basis of this searching mechanism matched relevant contacts are prioritized and comes up in the phonebook directory.

In its most basic configuration, a communication device describes herein typically includes at least one processing unit and memory. The memory may be volatile (such as RAM), non-volatile (such as ROM and flash memory), or some combination of the two.

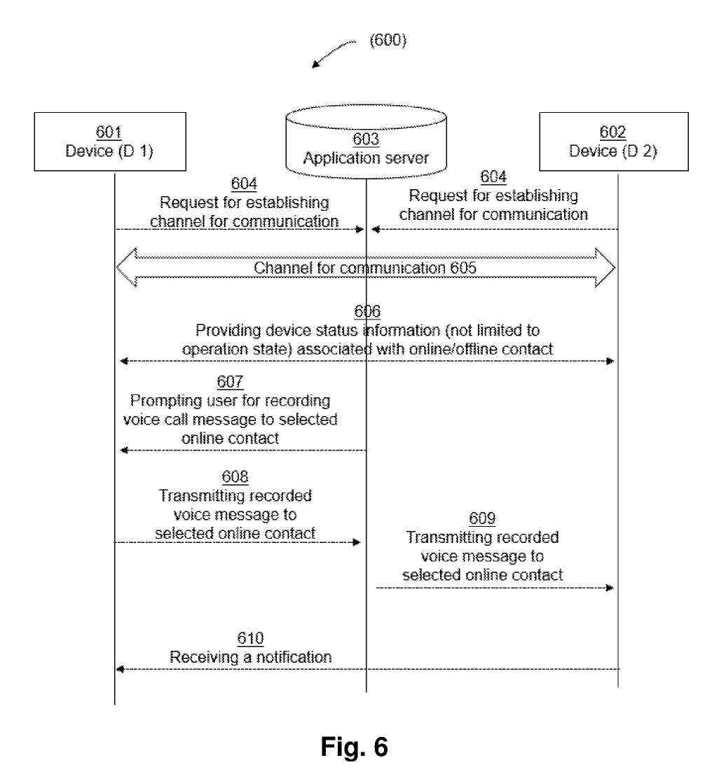

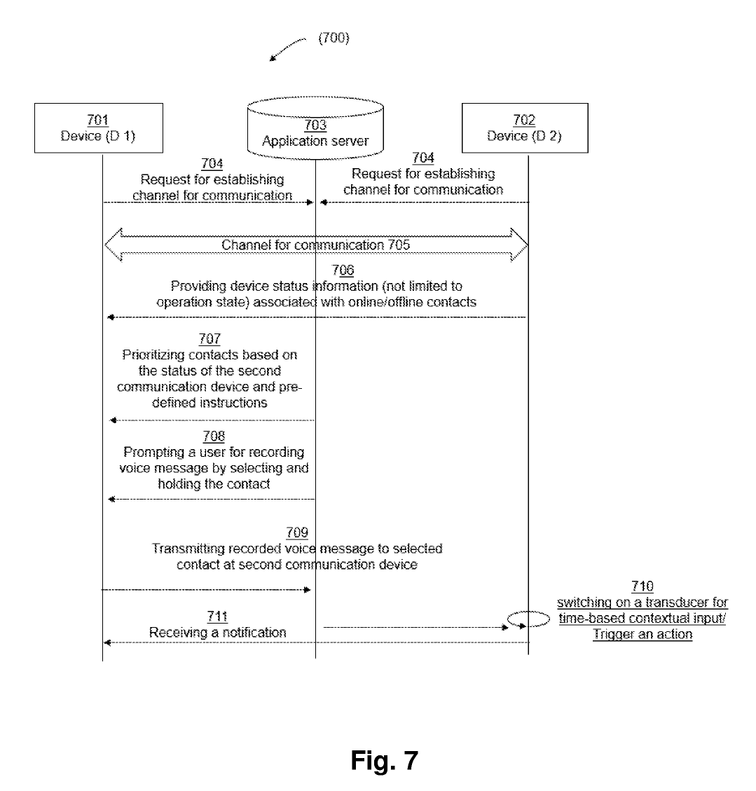

FIG. 6 and FIG. 7 show a diagram depicting an application request flow process between application server and communication devices according to an embodiment of present invention. An application server (603) monitors recently launched phonebook application on communication devices and keeps record of real time status data of all communication devices associated with contacts at server. This operation invoked by the phonebook directory application installed on each device, when application is launched in the device, a connection request is sent to application server (603). This request also comprises device information for establishing a communication channel with the server (603). Once a channel is established (605) each device connected to application sends real-time status information not limited to operation information, this may also include device information received from sensors such as microphone, gyroscope, light sensor, ambience sensor, and proximity sensor. Application server (603) shares, received status information in above steps with other associated second devices. When user selects and holds a contact on first device, audio/video recording function is invoked in background and cues to user for initiating audio/video recording (at step 607) until user hold the selection of contact. After audio/video message is recorded it is automatically transmitted (at step 608) to the application server and then forwarded (at step 609) to the second device, upon release of selection over the contact. Once user of receiving device plays message a notification is reverted back to the sender at step (610).

According to an embodiment explained in FIG. 7, once a channel for communication between server and devices are established, a real time status information is transmitted to the connected device by application server. This status information is utilized with other pre-defined user input for the prioritization of contacts at devices at step (707). Further, at step (710), reception of recorded message switch on a transducer for time based contextual input and also triggers an action. An action may comprises a command, audio alert and visual alert at second device.

According to another embodiment of present invention notification reverted back to the sender may comprises status information such as message is not played, pending, viewed, rejected, deleted etc.

According to another embodiment of present invention provides an automatic answering machine as an integrated feature of phonebook directory application installed devices. According to this embodiment when an audio/video message is received at recipient phone device the phone status information is detected, the status information can be operational state information or information received by sensors of the phone device. In response to it application configures the device to switching one transducers for providing user defined message as well as for receiving input command for automatically playing audio/video message, without requiring to touch the phone device. The transducers may comprise such as microphone, speaker, and device sensors. The input command can be inform of an audio/voice command, gesture input, and sensors information received due to user performed action.

For an example a phonebook directory application installed devices are configured to play user defined message such as an introduction message like announcing the senders name on speakerphone when an audio/video message is received or giving a beep after every specified duration if a message is waiting or announcing the classification of audio/video message. Also the device turns on the transducers such as microphone in the background during the period and for some seconds (like 30 seconds) after the beep or intro and then analyzes the sound recording for a user input like a clap to automatically play the message on speakerphone. The message can be queued if the phone is on silent mode. Once the phone is removed from silent mode the phone may start the prompting process to play the message. This process helps the microphone to be turned on for limited times and save battery. However, in the future the microphone may be permanently turned on if the batteries permit. The apparent advantage of this process is a hands free no-touch experience of receiving messages. Especially at night or for people who are in bed it can be operated without needing to find the phone. It is also convenient when the phone is on charging at a distance. It strikes a perfect balance between convenience and privacy of messaging at the same time.

In another embodiment the present invention directory installed device system periodically prompt the user to play the message by using an audible beep and listening for user command to play the message. The message could be either a prerecorded message or text-to-speech. The application also configures mobile device to beep after every fixed interval if a message is pending or a missed call is unviewed. The beeps may be suspended if the mobile phone is on silent. The beep configuration is further configurable on the type of messages or based on important senders. The beep itself could be of many types and sounds for a hands free experience.

In another embodiment the mobile device is configured to perform the following voice commands play new, play old, play next, play first, snooze, tell time and record reply. A clap or an equivalent verbal command ends the reply recording and the new recorded message is sent back to the original sender.

In another embodiment the mobile device is custom trained with audio/voice commands and actions that can be executed at the time of message beeps.

In another embodiment the mobile device has the microphone permanently tuned on. It however suffers the disadvantage of predictability of the environment and privacy and is not very desirable. It is therefore supplemented with an activation word to accept commands at any time to play the messages. However the utility of the sound based message indicator or reminder like a beep remains as it provides context and timing to the user input.

According to an embodiment of present invention the phone device is neither live nor completely offline. It is designed to minimize time and effort wastage. The calls are also not similar to PTT since they are two-way communications.

The device suggested above basically takes PTT to the 3g era where the data layer and software make the process of push to talk more complete and closed loop.

There may be other enhancements like the status of the target phone ringer may be updated preemptively on the sender devices. It makes it better for the sender device to decide if it is a good time to call or not. It may also show the phone power status or network signal strength or battery levels etc.

In another aspect of the invention the messaging system at the recipient phone may configured to receive the classification of the calls or messages as normal or emergency/SOS. Based on that the phone may be able to raise an alarm or unsilent the phone. There may be other actions configured to be triggered on such receiving of signal and the call and message be patched through.

In another aspect of the invention the phone may also show the local time at the recipient phone preemptively on the sender's phone book. It may be calculated based on either the current location of the target recipient or derived from his contact details stored locally.

In another aspect of the invention the phonebook may also preemptively update the preferred calling/messaging number of the target. The preferred number may be setup by the recipient either automatically based on event, location or manually.

In another aspect of the invention the phone books are connected through a common internet system and the contact and message statuses are exchanged between the relevant mobile devices.

According to an embodiment of present invention phonebook directory application device displays a list of public contacts or a directory without their contact information on a user device. Having the user select one of the contacts and send a private message, data or call. The message is then delivered to the target contact. The delivery may further happen on his preferred channel. It is especially useful in case of first contact or location directories for purposes other than sending joining request. It is useful for ad-hoc private communication with new people. It saves the effort of finding and saving a phone number of a person before being able to communicate. The secrecy could be maintained further by having a mediating server providing a bridge between the call or SMS connections and hiding the numbers.

The message may be a quick audio/video recording (Qviki) or a video recording that is initiated by a long press of a button on user name that is completed by a single long click for ultra-convenience. It is especially useful for the sender when driving, eating food or being busy working.

Further the Qviki may be auto received, played at the receiving end. The Qviki can also announce the sender's name before playing the message to avoid confusion. This further helps the receiver to have hands free listening experience. He may also not need to refer to the screen or be near his phone to receive the message. The message playing may automatically use the phone's hand free speaker and auto play the message. The auto play settings may be set for Qviki received from select important people in the phone directory. Further the Qviki play confirmation may be sent back to the sender automatically. The confirmation of play may further be played automatically on the sender's phone hands free speaker. The receiver may also snooze the play of the message using the touch interface or audio/voice command if he is busy at the time. He may also send a single click response from a set of options presented to the receiver back to the sender. The response may be read to the sender on the speakerphone again. The Qviki could be either sent through a mediating server between receiver and sender or through the telecom interface. The Qviki may be enabled on the receiver device to be only auto played when received from specific users and the rest may be queued. The other benefit is the user saves time by not having to wait for voicemail or call ringing. The user may leave a detailed message without having to type and disturbed or wait for the receiver to pick a call.

The Qviki can be queued either on the server or the phone till the receiving phone becomes available for automatic play. For example the Qviki may be queued if the user is on call or the phone is on silent mode. It will be played automatically as soon as the phone is available or the ringer is activated.

Ideal example is a Qviki sent to his secretary on the desk to come into his office with a single click on the secretary's name or contact info.

Now, a user may want to initiate a call to a contact with a single click and the caller may be on the receiver's preferred list configured for auto pickup and transfer to hands free. The caller information may be introduced on the speaker before call is enabled. A beep may be played on the speaker every few seconds to make receiver aware of the phone being on call. The call may or may not be routed through the regular telecom network.

The whole calling interface may be optimized to generate a dynamic directory of last used contacts in certain duration like last 7 days. The user does not have to maintain favorites and the search on such directory reduces the keystrokes that need to be pressed to reach a contact. This current directory is better than a recent call list due to being searchable and having unique callers. The shortness of such list helps reducing the scroll to reach a contact that was recently used.

Further the contact list may show the user status before even calling like if the phone is reachable, or with the person. If the person is at same location or in city the status could be auto updated on the server by all connected phones and then distributed to all relevant contact books.

The above interface is better than audio/voice dialing. It is more accurate in its overall delivery while saving more time of the users. The time can be saved in following stages
Searching the contact in last 7 days or sorting according to last called.
Click on name to directly record or dial, (long press on the search screen)
Offline record and send to skip ringing and pickup procedure.
Auto play instead of ringing or answering.
Auto introduction before play for getting attention and listening from far distance.
Auto status response of message delivery and listening.
One click replies on messages.
Confirmation auto play on senders phone that message has been delivered.

The system described above is very different from Walkie-talkie or push-to talk. It has auto-announcement, offline messaging, auto-play and message read status.

The embodiment of the present invention is not limited to voice message only, it can be a video, data or text to speech message.

A contact of phonebook directory is referred as contact information and may comprise name of contact person, phone number, email, and other information.

A web server described herein provides a portal for audio/video message access through a web interface. Thus terms like web portal and web server are used interchangeably and synonymously throughout this document.

All references of device may be assumed as communication device interchangeably and includes mobile phone, phone device, tablets, portable device and computing device. Further, terms like “server” “system” and “platform” are used interchangeably and synonymously throughout this document.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. A method for delivering at least one audio or video message, said method comprising the steps of:
receiving, at a display of a first communication device (601), selection of a recipient contact from a user, and simultaneously cueing to initiate recording of the audio or video message for the recipient while holding the recipient contact;
receiving, at the first communication device (601), the recorded audio or video message; and
transmitting, from the first communication device (601), the recorded audio or video message to a server (603), wherein the server (603), transmits the recorded audio or video message to the recipient based on whether the recipient is a registered contact that is registered with the server, or is an unregistered contact that is not registered with the server such that in case the recipient is a registered contact, the recorded audio or video message is transmitted over a data network to a second communication device (602) of the recipient, whereas in case the contact is an unregistered contact, a unique link is sent to the second communication device (602) of the recipient using mobile network, which when clicked by the recipient, directs the recipient to register or view the recorded audio or video message.

2. (canceled)

3. The method of claim 1, wherein the method further comprises the steps of:
receiving, at the second communication device (602), the recorded audio or video message;
detecting, on the second communication device (602), status thereof;
switching on, at the second communication device (602), one or more transducers configured to receive an input from the recipient without requiring physical touch of the recipient on the second communication device (602); and
automatically playing, on the second communication device (602), the received recorded audio or video message based on the detected status or the user input.

4. The method of claim 1, wherein selection of the contact is performed on a contact list, and wherein the contact list is any or a combination of a contact list maintained locally on the first computing device (601), or a contact list maintained at the server 603).

5. The method of claim 1, wherein the second communication device (602) is any of a mobile phone or a smart phone, and wherein the unique link is sent to the second communication device using mobile number of the recipient.

6. The method of claim 3, wherein status of the second communication device (602) comprises any or a combination of busy, online/available, engaged, conversing, listening, out-of-range, and offline/not logged on, and a state detected by a sensor.

7. The method of claim 1, wherein selection of the recipient from a contact list is prioritized by:
Displaying one or more contacts of the contact list, wherein the one or more contacts comprise one or more field sections;
receiving an alphanumeric characters entry as a search string from the user;
initiating searching in the one or more fields of the one or more contacts based on the search string;
sorting the contacts based on matches beginning with the search string and then later containing the search string;
further sorting the contacts based on matched fields having higher importance within the contacts having same sort order;
further sorting contacts based on usage within the contacts having same order; and
presenting the sorted contacts in the contact list, based on which the user then selects the recipient.

8. A method of automatically delivering an audio or video message, said method comprising the steps of:
receiving, at a communication device (602) of a recipient, a audio or video message transmitted by a sender;
detecting, on the communication device (602), status thereof;
switching on, at the communication device (602), one or more transducers configured to receive an input from the recipient without requiring physical touch of the recipient on the second communication device; and
automatically playing, on the communication device (602), the received audio or video message based on the detected status or the user input.

9. The method of claim 8, wherein status of the communication device (602) comprises any or a combination of busy, online/available, engaged, conversing, listening, out-of-range, and offline/not logged on, and a state detected by a sensor.

10. The method of claim 8, wherein the one or more transducers are selected from a group comprising microphone, camera, gyroscope, light sensor, ambience sensor, and proximity sensor.

11. The method of claim 8, wherein the switching on the one or more transducers comprising controlling the transducers operation on time based functioning.

12. The method of claim 8, wherein the switching on one or more transducers comprises prompting the user through one of an audible and visual indication for an input.

13. The method of claim 8, wherein automatically playing the received audio or video message comprises prompting the user for an input.

14. The method of claim 8, wherein the recipient input comprises at least one of an audio/voice command, gesture input and sensors information.

15. The method of claim 8, wherein the one or more transducers are further configured to receive time-based contextual input.

16. The method of claim 8, wherein the one or more transducers are configured to trigger an action.

17. The method of claim 8, wherein the automatically playing the audio or video message at the communication device further comprises announcing a user defined message.

18. The method of claim 17, wherein the user defined message comprises at least one of an audio alert, visual alert, contact name of the sender, and classification of the audio/video message.

19. The method of claim 18, wherein the classification of the message comprises at least one of a normal, emergency and SOS.

20. The method of claim 8, wherein the audio or video message is queued based on a first detected status such that the message is played once the first detected status changes to a second detected status that allows playing of the message.

21. The method of claim 8, wherein the sender selects the recipient from a contact list displayed on sender's communication device, and wherein the contact list indicates the status of the recipient's communication device to enable the sender to send the audio or video message based on the status of the recipient's communication device.
